(19) United States
(12) Patent Application Publication
(10) Pub. No.: US 2006/0187160 A1
(43) Pub. Date: Aug. 24, 2006

(54) Method for solving feed-through effect

(76) Inventor: Chih Chang Lai, Taiping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/063,771

(22) Filed: Feb. 24, 2005

(51) Int. Cl. G09G 3/36

(52) U.S. Cl. 345/88

(57) ABSTRACT

A method for solving feed-through effect, including steps of: obtaining desired gamma voltage value from a V-T curve (effective voltage-transmission curve) of the Liquid crystal and a gamma curve (gray scale-transmission curve); obtaining positive and negative frame feedback values by means of the desired gamma voltage value and the transistor reference data; adding the feedback values to obtain updating positive and negative frame gamma curve values; inputting the updating gamma curve values into the driving IC of the display; and through the feed-through effect, dropping the updating gamma curves back to the desired gamma curves, whereby the picture of the display will not flicker without adjusting V_{com} DC bias.

### BACKGROUND OF THE INVENTION

The present invention is related to a method for solving feed-through effect, and more particularly to a method which solves the feed-through effect by means of inputting the positive and negative frame feedback values into the driving IC of the display.

The feed-through effect of a common thin film transistor (TFT) liquid crystal display is mainly generated by parasitic capacitor of the TFT device. The feed-through effect will indirectly affect the correctness of the display of gray level and result in flickering of the picture. With the C_{S} on common TFT subpixel cell shown in FIG. 6 exemplified, the gate of the transistor Q is connected with the gate line G, while the source is connected with the data line S. The parasitic capacitor C_{GD} is connected with the gate line G and the drain of the transistor Q as well as connected with the liquid crystal capacitor C_{LC} and the storage capacitor C_{S}. The liquid crystal capacitor C_{LC} and the storage capacitor C_{S} are further connected with common electrode V_{com}.

Referring to FIGS. 7A and 7B, the VG signal is the scanning signal of TFT. When the VG signal goes from V_{gh} (scanning signal high level) to V_{gl} (scanning signal low level), the voltage of video signal V_{S} will be affected through the capacitance coupling of the parasitic capacitor C_{GD} to generate feed-through effect (as ΔVₚ and ΔVₙ of FIG. 7B). As a result, the picture on the display will flicker. This phenomenon can be seen in view of gamma curve. As shown in FIGS. 3 and 4, an original gamma value is input and after going through the feed-through effect, a gamma value with feed-through effect is obtained. This gamma value will cause flickering of the picture. This is because the voltage of the positive gamma value is different from the voltage of the negative gamma value. In order to obviate the feed-through effect, many processes and circuits have been developed for reducing ΔVₚ and ΔVₙ. For example, U.S. Pat. No. 6,256,010B1 and Taiwanese Patent Publication Nos. 564645, 573284 and 527497. However, all these Patents fail to teach that by means of adjusting the gamma curve, the affection of feed-through effect can be solved. The following are the existent processes for solving feed-through effect:
1. Solving feed-through effect through driving manner:
   (1) Adjustment of V_{com} DC bias: Only the quotient of the total of positive and negative frame feed-through voltages divided by 2 is compensated, while the feed-through effect can be hardly truly compensated.
   (2) 3-level drive: The feed-through effect caused by liquid crystal capacitor C_{lc} cannot be compensated and the drive is complicated.
(3) 4-level drive: The drive is complicated.
2. Solving feed-through effect through manufacturing procedure: The feed-through effect can be only solved by means of reducing the valve of parasitic capacitor C_{gd} or increasing the value of Cₛₜ, for example, U.S. Pat. Nos. 6,107,641, 6,019,796 and 60,202,232.
3. Solving feed-through effect through layout: The valve of the parasitic capacitor C_{gd} is reduced through layout so as to reduce voltage drop caused by feed-through effect, for example, U.S. Pat. No. 6,028,650.
4. Solving feed-through effect by means of adding circuits on the panel: A sampling circuit is designed for feeding back the voltage drop caused by the feed-through effect, for example, Taiwanese Patent No. 591594. Alternatively, a compensating capacitor can be designed in each pixel for compensating the feed-through effect, for example, Taiwanese Patent No. 594347. However, both will make the apparatus more complicated.

### SUMMARY OF THE INVENTION

It is therefore a primary object of the present invention to provide a method for solving feed-through effect. The desired gamma voltage values are obtained from a V-T curve of the Liquid crystal and a gamma curve. When adjusting the desired gamma curve, the parasitic capacitor of the TFT device is by the way compensated for the feed-through effect. Therefore, it is unnecessary to increase the circuits of the panel or complicate the manufacturing procedure. Moreover, by means of simple adjustment, the flickering of the picture of the display caused by feed-through effect can be avoided.

According to the above object, the method for solving feed-through effect of the present invention includes steps of: obtaining desired gamma voltage value from a V-T curve (effective voltage-transmission curve) of the Liquid crystal and a gamma curve (gray scale-transmission curve); obtaining positive and negative frame feedback values by means of the desired gamma voltage value and the transistor reference data; adding the feedback values to obtain updating positive and negative frame gamma curve values; inputting the updating gamma curve values into the driving IC of the display; and through the feed-through effect, dropping the updating gamma curves back to the desired gamma curves, whereby the picture of the display will not flicker without adjusting V_{com} DC bias.

The present invention can be best understood through the following description and accompanying drawings wherein:

### BRIEF DESCRIPTION OF THE DRAWINGS

FIG. 1 is a flow chart of the method for solving feed-through effect of the present invention;

FIG. 2A is a desired gamma curve (gray scale-transmission curve) for selecting gamma values;

FIG. 2B is a V-T curve (effective voltage-transmission curve) corresponding to the gamma values of FIG. 2A for obtaining selected voltage values;

FIG. 3 is video signal-gray level curves of the present invention and the prior art, with the desired gamma value equals 2.2 under positive frame, showing the original gamma curve, gamma curve with feed-through effect and updating gamma curve;

FIG. 4 is video signal-gray level curves of the present invention and the prior art, with the desired gamma value equals 2.2 under negative frame, showing the original gamma curve, gamma curve with feed-through effect and updating gamma curve;

FIG. 5 shows a V_{com} voltage-time diagram of the present invention;

FIG. 6 is a circuit diagram of a conventional C_{S} on common TFT subpixel cell;

FIG. 7A is a time-voltage diagram of the scanning signal VG of the TFT of FIG. 6; and

FIG. 7B is a time-voltage diagram of the video signal V_{S} of the TFT of FIG. 6.

### DETAILED DESCRIPTION OF THE PREFERRED EMBODIMENTS

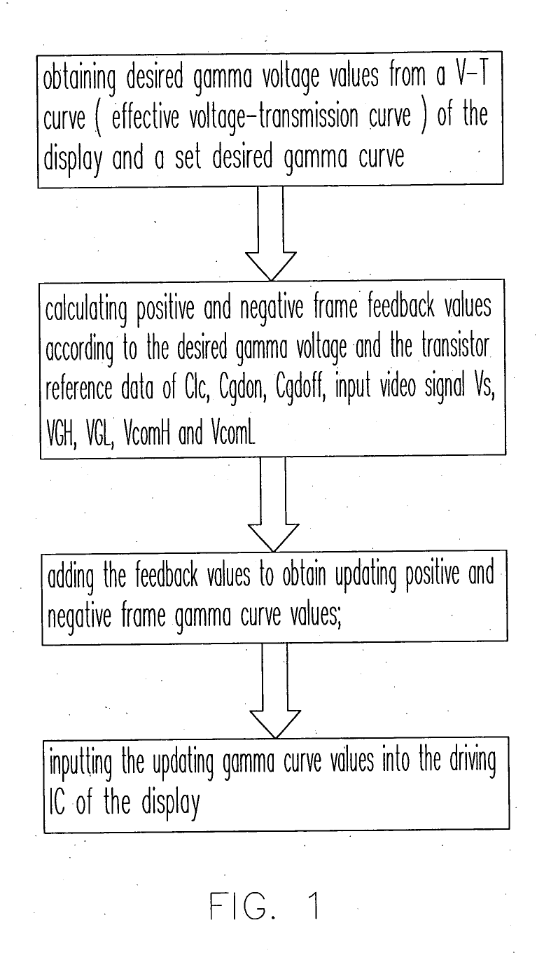

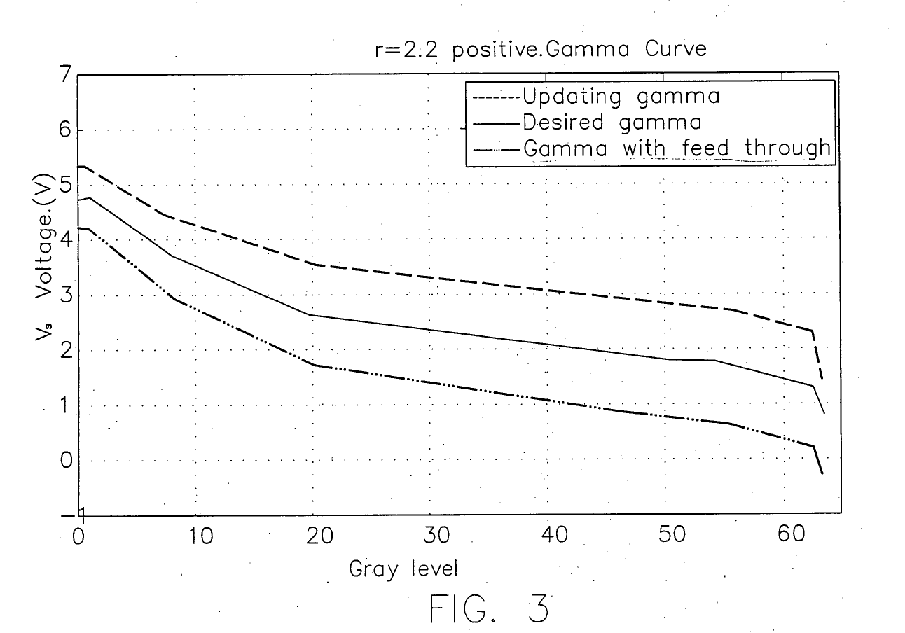

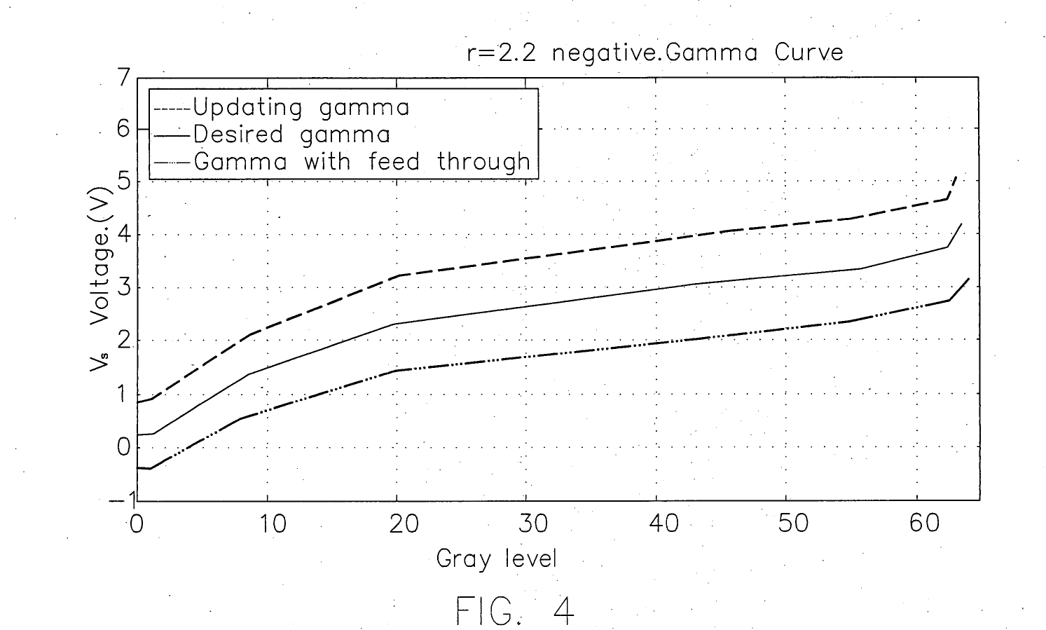

Please refer to FIG. 1. The method for solving feed-through effect of the present invention includes steps of:
1. obtaining desired gamma voltage value from a known V-T curve (effective voltage-transmission curve) of the Liquid crystal and a set desired gamma curve (gray scale-transmission curve);
2. via feed-through voltage drop formula, calculating positive and negative frame feedback values according to the desired gamma voltage value and the transistor reference data of C_{lc} (liquid crystal capacitance), C_{gdon} (capacitance when parasitic capacitor is turned on), C_{gdoff} (capacitance when parasitic capacitor is turned off), input video signal Vₛ, scanning signal high level VGH, scanning signal low level VGL, common electrode signal high level V_{com}H and common electrode signal low level V_{com}L;
3. adding the feedback values to obtain updating positive and negative frame gamma curve values;
4. inputting the updating gamma curve values into the driving IC of the display;.and
5. through the feed-through effect, dropping the updating gamma curves back to the desired gamma curves (as shown in FIGS. 3 and 4), whereby the picture of the display will not flicker without adjusting V_{com} DC bias.

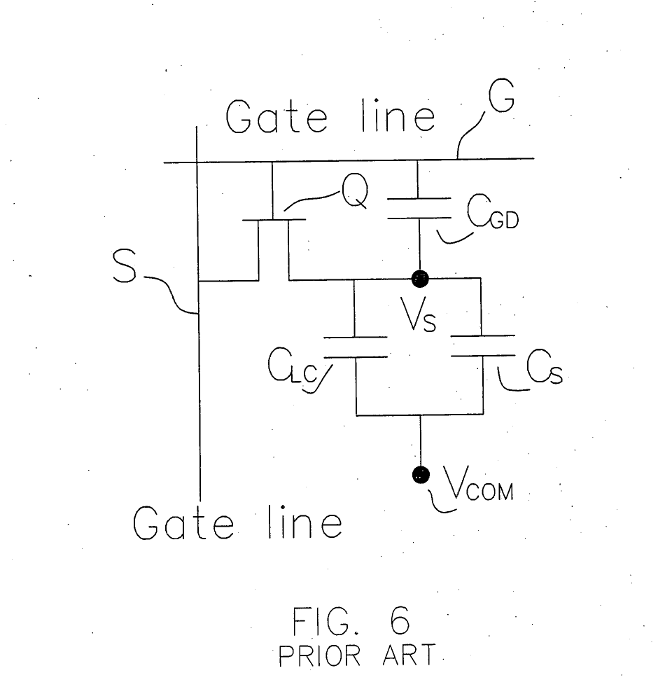

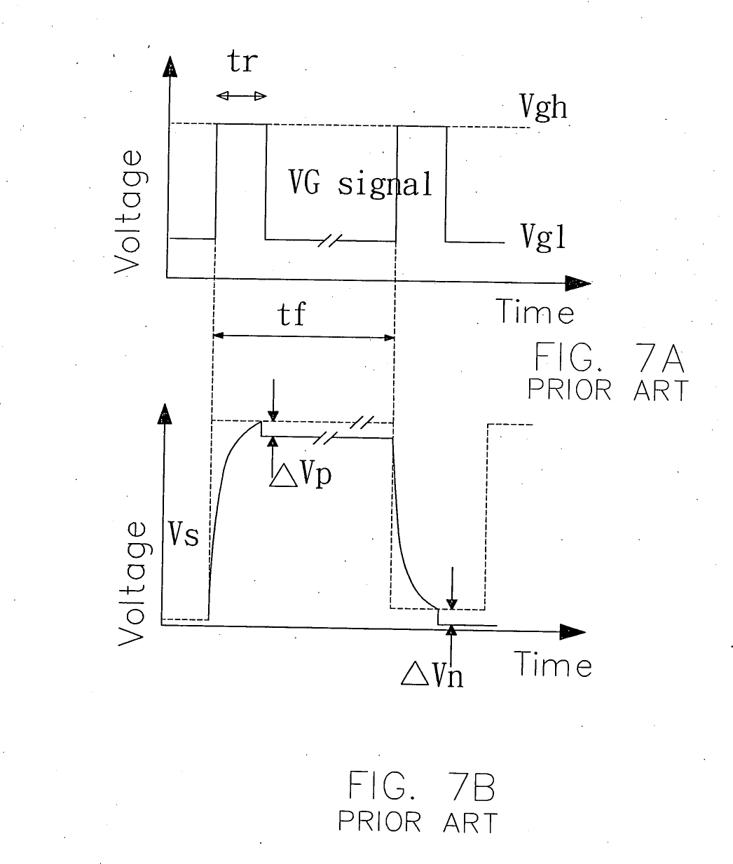

The present invention is applicable to the conventional C_{S} on common TFT sub-pixel cell as shown in FIG. 6. The reference data for successive application are obtained via the feed-through voltage drop formulae derived from the feed-through effect. The feed-through voltage drop formulae are as follows (V_{com} signal has a form of 0˜5 volt AC):
positive frame voltage drop:

$$Δ {V}_{p} = \frac{{C}_{gdon} ( {V}_{gh} - {V}_{sp} ) + {C}_{gdoff} ( {V}_{sp} - {V}_{gl} )}{{C}_{gdoff} + {C}_{st} + {C}_{lc}} ,$$

negative frame voltage drop:

$$Δ {V}_{n} = \frac{{C}_{gdon} ( {V}_{gh} - {V}_{sn} ) + {C}_{gdoff} ( {V}_{sn} - {V}_{gl} )}{{C}_{gdoff} + {C}_{st} + {C}_{lc}} ,$$

wherein:
C_{gdon} means the capacitance when the parasitic capacitor C_{GD} is turned on;
C_{gdoff} means the capacitance when the parasitic capacitor C_{GD} is turned off;
V_{gh} means high voltage level of scan signal;
V_{gl} means low voltage level of scan signal;
Vₛₚ means the value of the video signal Vₛ input by the positive frame; and
Vₛₙ means the value of the video signal Vₛ input by the negative frame.

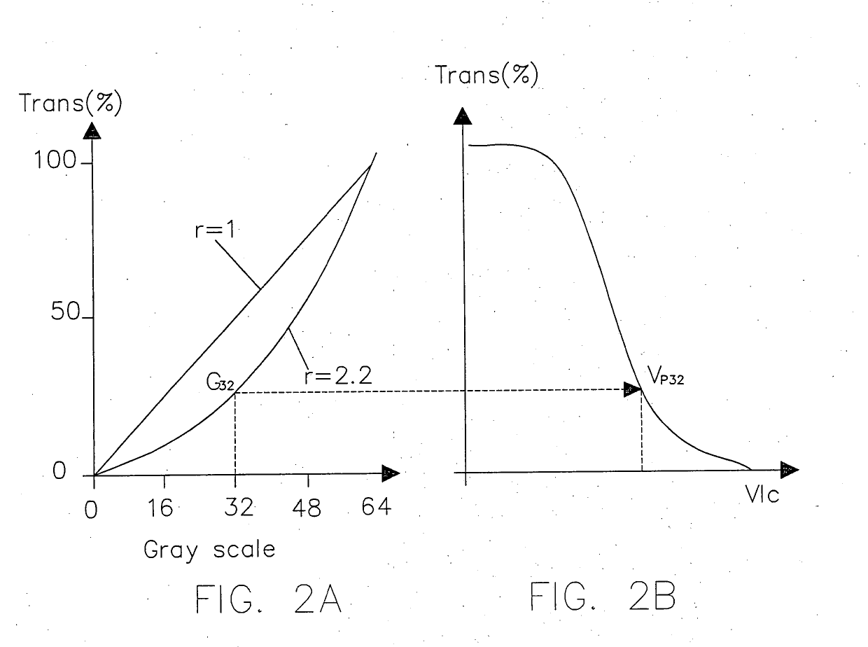

Presuming Vₚ32 (representing input voltage of gray scale 32) of FIG. 2B is to be sought from a known V-T curve (effective voltage-transmission curve as shown by FIG. 2A) of the liquid crystal and gamma=2.2 curve (gray scale-transmission curve as shown by FIG. 2B), first it is necessary to select a preset gamma curve value. With gamma=2.2 exemplified, as shown in FIG. 2A, point G₃₂ is obtained from gray scale 32 and then by means of drafting method, the point is rightward reflected to V-T curve of FIG. 2B to obtain Vₚ32, that is, the voltage of gray scale 32 with gamma=2.2. Similarly, the gray scale voltages of eight points of the positive frame can be correspondingly obtained as follows:
Vₚ0=4.78
Vₚ1=4.76
Vₚ8=3.7
Vₚ20=2.65
Vₚ43=1.98
Vₚ55=1.69
Vₚ62=1.28
Vₚ63=0.86

Furthermore, eight negative frame points are calculated by means of the eight positive frame points as follows (V_{com} signal has a form of AC and the negative frame points are different from the positive frame points by 5 volts):
Vₙ0=(5−4.78)=0.22
Vₙ1=(5−4.76)=0.24
Vₙ8=(5−3.7)=1.3
Vₙ20=(5−2.65)=2.35
Vₙ43=(5−1.98)=3.02
Vₙ55=(5−1.69)=3.31
Vₙ62=(5−1.28)=3.72
Vₙ63=(5−0.86)=4.14

The fee-through voltages of these points of positive and negative frames are calculated. Then the gamma curves are compensated with the feed-through voltages to obtain updating gamma curve values.

C_{gdon} unequal to C_{gdoff} and C_{lc} is not a constant.

C_{gdon}=0.01 P C_{gdoff}×0.005 P, C_{∥}=0.22 P, C_{⊥}=0.07 P

If |ΔV_{lc}|≦1, C_{lc1}=C_{⊥}=0.007 P

$$If 1 ≦ \vert Δ {V}_{lc} \vert ≦ 2 , {C}_{lc 2} = \frac{{C}_{lc 1} + {C}_{lc 3}}{2} = 0.1 P$$

$$If 2 ≦ \vert Δ {V}_{lc} \vert ≦ 3 , {C}_{lc 3} = \frac{1}{3} {C}_{‖} + \frac{2}{3} {C}_{⊥} = 0.12 P$$

$$If 3 ≦ \vert Δ {V}_{lc} \vert ≦ 4 , {C}_{lc 4} = \frac{{C}_{lc 3} + {C}_{lc 5}}{2} = 0.17 P$$

If ΔV_{lc}|≧4, C_{lc5}=C_{∥}=0.22 P

Cₛₜ=0.08 P, V_{gh}=15V, V_{gl}=−10V, V_{comH}=5V, V_{comL}=0V

The above reference data are obtained according to an embodiment of the present invention. The positive frame gamma curve is calculated as follows: (Vₚ₀=4.78V so that C_{lc}=0.22. The value of C_{lc} is varied with the value of Vₚ.)

$$\begin{matrix}Δ {V}_{p 0} = \frac{0.01 ( 15 - {V}_{p 0}^{′} ) + 0.005 ( {V}_{po}^{′} + 10 )}{0.005 + 0.08 + 0.22} \\ = \frac{- 0.005 {V}_{po}^{′} + 0.2}{0.305} ,\end{matrix}$$

$${V}_{p 0}^{′} - \frac{- 0.005 {V}_{p 0}^{′} + 0.2}{0.305} = {V}_{p 0} , \\ \begin{matrix}{V}_{p 0}^{′} = \frac{0.305 {V}_{p 0} + 0.2}{0.31} \\ = \frac{0.305 * 4.78 + 0.2}{0.31} \\ = 5.35 V\end{matrix}$$

Similarly Vₚ₁′==5.33V, Vₚ₈′==4.4V, Vₚ₂₀′==3.54V, Vₚ₄₃′==2.98V Vₚ₅₅′==2.7V, Vₚ₆₂′==2.3V, Vₚ₆₃′==1.41V Vₚ₀′, Vₚ₁′, Vₚ₈′, Vₚ₂₀′, Vₚ₄₃′, Vₚ₅₅′, Vₚ₆₂′, Vₚ₆₃′are the updating positive frame gamma curve The negative frame gamma curve is calculated as follow:

$$\begin{matrix}Δ {V}_{n 0} = \frac{0.01 ( 15 - {V}_{n 0}^{′} ) + 0.005 ( {V}_{no}^{′} + 10 )}{0.005 + 0.08 + 0.22} \\ = \frac{- 0.005 {V}_{no}^{′} + 0.2}{0.305} ,\end{matrix}$$

$${V}_{p 0}^{′} - \frac{- 0.005 {V}_{n 0}^{′} + 0.2}{0.305} = {V}_{n 0} , \\ \begin{matrix}{V}_{n 0}^{′} = \frac{0.305 {V}_{n 0} + 0.2}{0.31} \\ = \frac{0.305 * 0.22 + 0.2}{0.31} \\ = 0.86 V\end{matrix}$$

Similarly Vₙ₁′=0.88V, Vₙ₈′=2.04V, Vₙ₂₀′=3.25V, Vₙ₄₃′=3.99V, Vₙ₅₅′=4.28V, Vₙ₆₂′=4.67V, Vₙ₆₃′=5.26V Vₙ₀′, Vₙ₁′, Vₙ₈′, Vₙ₂₀′, Vₙ₄₃′, Vₙ₅₅′, Vₙ₆₂′, Vₙ₆₃′ are the updating frame gamma curve The updated values obtained from the above calculation are as the follow table:

| | Desired Gamma | Gamma with feed | Updating Gamma |
|---|---|---|---|
| | level | through | level |
| Vp0 | 4.78 | 4.2 | 5.35 |
| Vp1 | 4.76 | 4.18 | 5.33 |
| Vp8 | 3.7 | 2.99 | 4.4 |
| Vp20 | 2.65 | 1.74 | 3.54 |
| Vp43 | 1.98 | 0.95 | 2.98 |
| Vp55 | 1.69 | 0.65 | 2.7 |
| Vp62 | 1.28 | 0.23 | 2.3 |
| Vp63 | 0.86 | −0.4 | 1.41 |
| Vn0 | 0.22 | −0.43 | 0.86 |
| Vn1 | 0.24 | −0.41 | 0.88 |
| Vn8 | 1.3 | 0.54 | 2.04 |
| Vn20 | 2.35 | 1.43 | 3.25 |
| Vn43 | 3.02 | 2.02 | 3.99 |
| Vn55 | 3.31 | 2.31 | 4.28 |
| Vn62 | 3.72 | 2.72 | 4.67 |
| Vn63 | 4.14 | 2.98 | 5.26 |

The updating gamma curves (as shown in FIGS. 3 and 4) obtained from the above eight gray scale voltage values of each of the positive and negative frames are input into the driving IC of the display. After going through the feed-through effect, the updating gamma curves will drop back to the original gamma curves as shown in FIGS. 3 and 4. Accordingly, the picture of the display will not flicker without adjusting V_{com} DC bias.

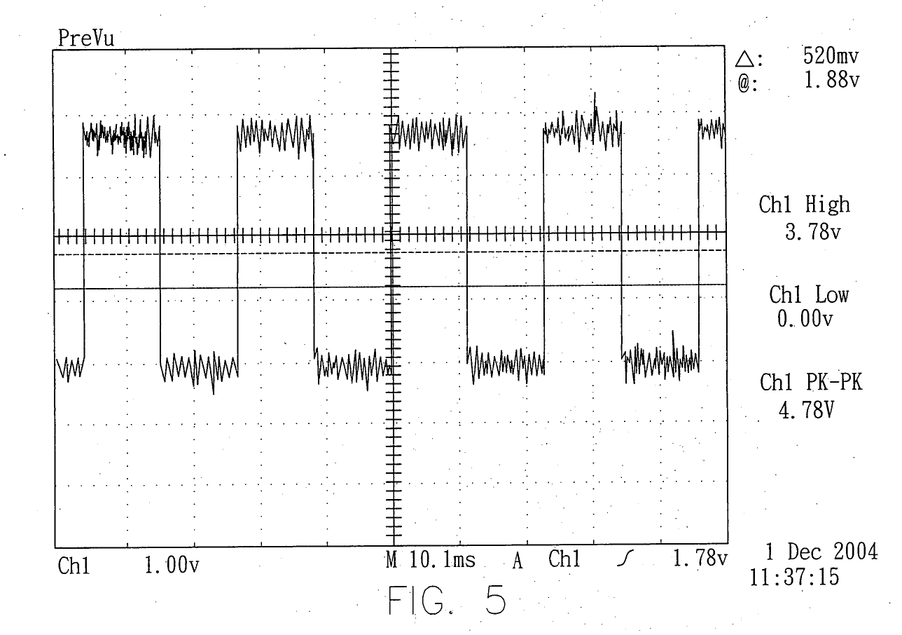

In conclusion, according to the method of the present invention, when adjusting the gamma curve, the parasitic capacitor of the TFT device can be by the way compensated for the feed-through effect. Therefore, it is unnecessary to increase the circuits of the panel or complicate the manufacturing procedure. Moreover, only the obtained feedback values are input into the IC of the display so that the adjustment is simple. Also, it is unnecessary to adjust the V_{com} DC bias as shown in FIG. 5, wherein V_{com}H=4.78V, while V_{com}L=0V.

The above embodiments are only used to illustrate the present invention, not intended to limit the scope thereof. Many modifications of the above embodiments can be made without departing from the spirit of the present invention.

What is claimed is:

1. A method for solving feed-through effect, comprising steps of:
(1) obtaining desired gamma voltage values from a V-T curve (effective voltage-transmission curve) of a liquid crystal and a gamma curve (gray scale-transmission curve);
(2) obtaining positive and negative frame feedback values by means of the desired gamma voltage value and the transistor reference data;
(3) adding the feedback values to obtain updating positive and negative frame gamma curve values;
(4) inputting the updating gamma curve values into the driving IC of the display; and
(5) through the feed-through effect, dropping the updating gamma curves back to the desired gamma curves, whereby the picture of the display will not flicker without adjusting V_{com} DC bias.

2. The method for solving feed-through effect as claimed in claim 1, wherein the desired gamma voltage value and the transistor reference data include C_{lc} (liquid crystal capacitance), C_{gdon} (capacitance when parasitic capacitor is turned on), C_{gdoff} (capacitance when parasitic capacitor is turned off), input video signal Vₛ, scanning signal high level VGH, scanning signal low level VGL, common electrode signal V_{com}.

3. The method for solving feed-through effect as claimed in claim 1, wherein the positive and negative frame feedback values are calculated via feed-through voltage drop formula.
